(19) United States
(12) Patent Application Publication
(10) Pub. No.: US 2021/0277226 A1
(43) Pub. Date: Sep. 9, 2021

(54) HIGH PLA CONTENT PLASTIC MATERIAL COMPRISING LACTIC ACID OLIGOMERS

(71) Applicant: CARBIOLICE, Riom (FR)

(72) Inventors: Madiha ALOUI DALIBEY, Clermont-Ferrand (FR); Clementine ARNAULT, Clermont-Ferrand (FR)

(21) Appl. No.: 17/258,119

(22) PCT Filed: Jul. 5, 2019
(86) PCT No.: PCT/EP2019/068096

§ 371 Date: Jan. 5, 2021

(30) Foreign Application Priority Data
Jul. 6, 2018 (FR) 1870811

(51) Int. Cl. C08L 67/02; C08J 5/18

(52) U.S. Cl. CPC C08L 67/02; C08J 5/18; C08L 2205/035; C08J 2433/10; C08L 2205/08; C08J 2367/02; C08J 2467/02; C08L 2205/025

(57) ABSTRACT

The present invention relates to a plastic composition based on biodegradable and bio-based polyesters, in particular for the preparation of plastic films.

### FIELD OF THE INVENTION

The present invention relates to a plastic composition based on biodegradable and bio-based polyesters, in particular for the preparation of plastic films.

### STATE OF THE ART

Bio-based and biodegradable films, based on starches or starch derivatives and polyester, in particular monolayer or multilayer films, are known to be used in particular for the manufacture of plastic bags. These bags are used in particular for the packaging of food products, particularly fruit and vegetables.

Particular mention may be made of the films described in patents and patent applications U.S. Pat. Nos. 6,841,597, 5,436,078, WO 2007/118828, WO 2002/059202, WO 2002/059199, WO 2002/059198, U.S. Pat. No. 9,096,758, WO 2004/052646, WO 2012/141660, US 2005/0154114 and CN 106881929. Bio-based and/or biodegradable materials used to maintain the mechanical properties adapted to their use remain expensive.

Increasing the polylactic acid (PLA) content makes it possible to increase the content of less expensive bio-based materials, such as in biodegradable resin compositions (WO 2018/056539). This increase in PLA content usually requires the use of a compatibilizer to allow the PLA to be mixed with another polyester, such as polybutylene adipate terephthalate (PBAT). Such compatibilizers are known for this use, in particular polyacrylates, such as the products marketed under the names Joncryl® ADR (Dong & al., International Journal of Molecular Sciences, 2013, 14, 20189-20203; Ojijo & al., Polymer 2015, 80, 1-17; EP 1 699 872; EP 2 258 775; EP 2 679 633; WO 2013/164743; WO 2015/057694).

However, the increase in PLA content is to the detriment of the mechanical properties of the products prepared with these polymer compositions. Thus, films obtained with such high-PLA-content compositions, despite the addition of compatibilizer, have reduced mechanical properties compared with films with less PLA, particularly in terms of elongation at break and tear resistance. In fact, increasing the PLA content in the compositions of the state of the art does not meet bag manufacturing specifications.

The invention solves this technical problem by adding a particular plasticizer to the mixture of polyesters and compatibilizer.

### DISCLOSURE OF THE INVENTION

The invention relates to a plastic composition which comprises

a. at least 20% by weight polylactic acid (PLA),
b. at least 45% by weight of a polyester selected from polybutylene adipate terephthalate (PBAT), polyhydroxyalkanoates (PHAs), polybutylene succinate (PBS), polybutylene succinate adipate (PBSA) and mixtures thereof,
c. a PLA/polyester compatibilizer, and
d. a plasticizer selected from lactic acid oligomers (OLAs).

The invention also relates to a plastic film the composition of which comprises a composition according to the invention, in particular obtained by extrusion of a composition according to the invention.

Finally, the invention relates to a process for preparing a composition according to the invention which comprises at least the successive steps of mixing and melting with

1. the PLA and the compatibilizer, then
2. the polyester selected from polybutylene adipate terephthalate (PBAT), polyhydroxyalkanoates (PHAs), polybutylene succinate (PBS), polybutylene succinate adipate (PBSA) and mixtures thereof,

the plasticizer selected from OLAs which can be added at any time during the process.

### DETAILED DESCRIPTION OF THE INVENTION

The invention relates to a plastic composition which comprises

a. at least 20% by weight polylactic acid (PLA),
b. at least 45% by weight of a polyester selected from polybutylene adipate terephthalate (PBAT), polyhydroxyalkanoates (PHAs), polybutylene succinate (PBS), polybutylene succinate adipate (PBSA) and mixtures thereof
c. a PLA/polyester compatibilizer, and
d. a plasticizer selected from lactic acid oligomers (OLAs).

Unless otherwise specified, percentages are given by weight in relation to the total weight of the composition to which they refer.

The constituents of the composition according to the invention are well known to the person skilled in the art, notably described in the publications, patents and patent applications cited above, in particular the polyesters and PLA commonly used in the biodegradable and/or bio-based plastics industry, in particular for producing bio-based and biodegradable films.

PLA is formed from levorotatory (L) lactic acid monomers and/or dextrorotatory (D) monomers, with the level of (L) and (D) monomers being variable. PLA can be a mixture of levorotatory PLA (PLLA), which is formed from predominantly (L) monomers, and dextrorotatory PLA (PDLA), which is formed from predominantly (D) monomers.

Advantageously, the polyester b) is PBAT. When used in mixture with other polyesters such as PHAs, PBS or PBSA, PBAT is in majority proportion in the mixture of polyesters other than PLA, preferably more than 60% of the mixture, more preferentially more than 70% even more preferentially more than 80% by weight. According to a particular and preferred embodiment of the invention, the polyester b) other than PLA is essentially PBAT, more preferentially consists only of PBAT.

PLA/polyester compatibilizers are well known to the skilled person, in particular selected from polyacrylates, terpolymers of ethylene, acrylic ester and glycidyl methacrylate (for example, marketed under the brand name Lotader® by the firm Arkema), PLA-PBAT-PLA triblock copolymers, maleic anhydride-grafted PLA (PLA-g-MA) or maleic anhydride-grafted PBAT (PBAT-g-MA).

According to a preferred embodiment of the invention, the compatibilizer is selected from polyacrylates, advantageously selected among methacrylate derivatives, preferentially the compatibilizer is poly(ethylene-co-methyl acrylate-co-glycidyl methacrylate). Such compatibilizers are well known and described in particular by Dong & al. (International Journal of Molecular Sciences, 2013, 14, 20189-20203) and Ojijo & al. (Polymer 2015, 80, 1-17). A preferred compatibilizer is poly(ethylene-co-methyl acrylate-co-glycidyl methacrylate) marketed under the name JONCRYL® ADR-4468- by the firm BASF.

OLAs are also plasticizers known to the skilled person, in particular as bio-based materials. They are lactic acid oligomers with a molecular weight of less than 1500 g/mol. They are preferably esters of lactic acid oligomers, their carboxylic acid end being blocked by esterification with an alcohol, in particular a linear or branched C1-C10 alcohol, advantageously a C6-C10 alcohol, or a mixture thereof. Particular mention may be made of the OLAs described in patent application EP 2 256 149 with their method of preparation, and the OLAs marketed by the firm Condensia Quimica under the brand name Glyplast®, in particular the products Glyplast® OLA 2, which has a molecular weight of 500 to 600 g/mol, and Glyplast® OLA 8, which has a molecular weight of 1000 to 1100 g/mol. According to a preferred embodiment of the invention, the OLAs have a molecular weight of at least 900 g/mol, more preferably from 1000 to 1400 g/mol, more preferentially from 1000 to 1100 g/mol.

The molecular weight of the OLAs can be measured by size-exclusion chromatography (SEC) or mass spectrometry coupling a matrix-assisted laser desorption-ionization ionization source and a time-of-flight analyzer (MALDI-TOF) according to the usual methods for measuring the molecular weight of these oligomers.

Preferably, the composition according to the invention comprises at least 25% PLA, more preferentially at least 28% PLA, even more preferentially at least 30% PLA. The combination of the compatibilizer and plasticizer used according to the invention and in particular the selection of OLAs as plasticizers makes it possible to obtain PLA contents up to at least 35%, and even higher, up to about 50% PLA.

The polyester b) content is advantageously at least 50% of the total weight of the composition. According to an advantageous embodiment of the invention, the polyester b) content is comprised between 60 and 72%.

The compatibilizer c) content in the composition according to the invention is advantageously at least 0.1%, preferably from 0.5 to 2%, more preferentially from 0.5 to 1.5%, advantageously about 1% by weight in relation to the total weight of the composition.

The OLA plasticizer d) content in the composition according to the invention is advantageously at least 0.5%, preferably from 1 to 5%, more preferentially from 2 to 4%, advantageously about 3%, preferably 2.5%.

The composition according to the invention may comprise other usual additives used in the composition of plastics materials, in particular for the preparation of films, such as mineral or organic fillers, pigments or dyes, etc. In a particular example, the composition according to the invention may comprise calcium carbonate.

In a particular case, the composition according to the invention comprises in relation to the total weight of the composition

a. at least 25% by weight polylactic acid (PLA), preferentially at least 28%, more preferentially at least 30% PLA,
b. at least 60% by weight of a polyester selected from polybutylene adipate terephthalate (PBAT), polyhydroxyalkanoates (PHAs), polybutylene succinate (PBS), polybutylene succinate adipate (PBSA) and mixtures thereof
c. between 0.5 to 1.5% of a PLA/polyester compatibilizer selected from polyacrylates, and
d. between 2 to 4% of a plasticizer selected from lactic acid oligomers (OLAs).

The composition according to the invention may also comprise enzymes capable of degrading polyesters so as to improve the biodegradability of the film according to the invention. In a particular embodiment, the composition according to the invention may comprise enzymes capable of degrading PLA. Such enzymes and their mode of incorporation in thermoplastic films are known to the skilled person, in particular described in patent applications WO 2013/093355, WO 2016/198652, WO 2016/198650, WO 2016/146540 and WO 2016/062695. Preferentially these enzymes are selected from proteases and serine proteases. In a particular embodiment, the serine proteases are selected from proteinase K from Tritirachium album, or PLA-degrading enzymes derived from Amycolatopsis sp., Actinomadura keratinilytica, Laceyella sacchari LP175, Thermus sp. or Bacillus licheniformis, or commercially reformulated enzymes known to degrade PLA such as Savinase®, Esperase®, Everlase® or any enzyme of the subtilisin family CAS 9014-01-1 or any functional variant.

When the composition according to the invention also comprises polyester-degrading enzymes, in particular PLA-degrading enzymes, the enzyme complemented composition is advantageously the following:

From 80% to 98% by weight, preferentially from 90% to 98% by weight, of the previously defined PLA-rich composition and from 2 to 20%, preferentially from 2% to 10%, of an enzyme composition comprising from 0.0005 to 10% of enzyme associated with 50 to 95% of a low-melting-point polymer and optionally associated with a stabilizer. This stabilizer may be selected from polysaccharides, preferentially from natural gums such as gum arabic.

Said enzyme composition can be prepared via the extrusion of 50 to 95%, preferentially from 70 to 90%, of a low-melting-point polymer and from 5 to 50%, preferentially from 10 to 30%, of a liquid enzyme formulation comprising from 0.01 to 35% enzymes, from 19 to 60%, or even 65% water and from 15 to 70% stabilizer.

Such enzyme compositions and/or liquid enzyme formulations suitable for the preparation of PLA-rich polymer mixtures are in particular described in patent applications WO 2019/043145 and WO 2019/043134.

A preferred enzyme composition comprises in particular, from 50 to 95% of a low-melting-point polymer, in particular polycaprolactone (PCL), preferentially from 70 to 90%, from 0.001 to 10% enzymes, preferentially from 0.5 to 6%, or even 1 to 6%, and from 1.5 to 21% gum arabic, preferentially from 3 to 7%.

The complemented enzyme composition according to the invention will advantageously comprise
at least 20% PLA, advantageously at least 25% PLA
at least 40% PBAT
at least 0.08% PLA/PBAT compatibilizer, advantageously at least 0.5%.
at least 0.4% plasticizer selected from OLAs
at least 0.002% enzyme, advantageously at least 0.05%, and
at least 1.4% of a low-melting-point polymer, advantageously at least 1.5%.

The skilled person will know how to adapt the enzyme content, and consequently the content of low-melting-point polymer and other additives brought by the enzyme composition according to his objectives of the rate of degradation of PLA by the enzymes.

The invention also relates to a process for preparing compositions according to the invention, with the compounds described above, with their proportions, comprising the steps of

1. mixing the PLA and the compatibilizer at a temperature where the PLA is partially or completely melted, then
2. adding polyester selected from polybutylene adipate terephthalate (PBAT), polyhydroxyalkanoates (PHAs), polybutylene succinate (PBS), polybutylene succinate adipate (PBSA) and mixtures thereof at a temperature where the previously obtained mixture is partially or completely melted.

The plasticizer selected from OLAs can be added at any time during the process: at the time of step 1 with PLA and compatibilizer, between step 1 and step 2, at the time of step 2 with the polyester or after step 2.

In a particular case, the invention relates to a process for preparing a composition according to the invention comprising the steps of

1. mixing at least 25% by weight (in relation to the total weight of the composition of the invention) PLA and between 0.5% and 1.5% by weight compatibilizer at a temperature greater than or equal to 120° C., then
2. adding at least 60% of the polyester selected from polybutylene adipate terephthalate (PBAT), polyhydroxyalkanoates (PHAs), polybutylene succinate (PBS), polybutylene succinate adipate (PBSA) and mixtures thereof, at a temperature where the previously obtained mixture is partially or completely melted,

the addition of between 2 to 4% by weight of the plasticizer selected from OLAs which can be carried out at any time during the process.

The preparation of the composition is done according to the usual methods of the art, in particular by extrusion. The extruded molten mixture is then cooled to form granules then is generally transformed into an end product of particular shape (films, flexible or solid parts).

When the products prepared with the composition according to the invention also comprise polyester-degrading enzymes as defined above, the latter are added either at the time of preparation of the composition or at the time of preparation of the end products by mixing granules of the composition according to the invention, and the enzymes in a form suitable for their incorporation and according to the usual methods known to the skilled person.

To facilitate the incorporation of the enzymes into the composition according to the invention, the latter will be used advantageously in the form of an adapted composition, which allows both the conservation and transport of the enzymes, but also promotes their incorporation by preventing their degradation during this incorporation stage. Such compositions are known to the skilled person, and in particular described in patent applications WO 2019/043145 and WO 2019/043134.

In particular, the addition of enzymes to the composition according to the invention can be advantageously done as follows: mixing between 80% and 98% of a composition according to the invention, with between 2% and 20% of a composition comprising a polyester-degrading enzyme and in particular PLA, the percentages being given by weight in relation to the weight of the final composition.

The invention also relates to any plastic product consisting of or comprising elements of the composition according to the invention.

According to a first embodiment, the composition is in the form of granules prepared according to the usual techniques. These granules can be stored, transported, as granules used in the manufacture of plastic products, whatever their form and use, which can be called “end products”. They can be films, or flexible or solid parts with shapes and volumes adapted to their uses.

The methods for preparation of these end products are well known to the skilled person, including in particular the usual techniques of the plastics industry such as blown film extrusion, extrusion-blow molding, cast film extrusion, calendering and thermoforming, injection molding, compression molding, rotomolding, coating, lamination, expansion, pultrusion, compression-granulation. Such operations are well known to the skilled person, who will easily adapt the process conditions to the type of plastic products expected (for example temperature, dwell time, etc.).

The composition according to the invention is particularly suitable for making plastic films. The films according to the invention can be produced according to the usual methods of the art, in particular by extrusion-inflation. The films can be prepared directly at the outlet of the extrusion die used for the preparation of the composition according to the invention, or from granules of the composition according to the invention which are melted according to the usual techniques, in particular by extrusion.

The invention therefore also relates to a film of composition as previously defined, with or without enzymes. The films according to the invention may be monolayer or multilayer films. In the case of a multilayer film, at least one of the layers is of composition as previously defined.

The composition according to the invention is particularly adapted to be associated with polyester-degrading enzymes for the manufacture of biodegradable plastic films.
Plastic films, in particular monolayer films, with a composition as defined above, have both a high PLA content and retain mechanical properties as sought for the preparation of biodegradable and bio-based bags, in particular for mulching films, packaging, wrapping of non-food and food products, in particular food products.

To this end, the constituents of the composition according to the invention will preferentially be selected from products compatible with a food use.

The films according to the invention have advantageously a thickness of less than 100 μm, more advantageously less than 50 μm, 40 μm or 30 μm, preferentially less than 20 μm, more preferentially from 6 to 20 μm.

The plastic films obtained with the composition according to the invention advantageously have the following properties,
an elongation at break of greater than 130% longitudinally and more than 240% transversely, measured according to standard EN ISO 527-3, and/or
a tear resistance of greater than 30 N/mm in the transverse direction of the film, measured according to standard EN ISO 6383-1
   while having a high PLA content.
   The elongation at break of the plastic film obtained with the composition according to the invention is advantageously at least 170% longitudinally, preferably at least 200%.
   The tear resistance of the plastic film obtained with the composition according to the invention is advantageously at least 35 N/mm in the transverse direction of the film, preferably at least 40 N/mm, more preferentially at least 45 N/mm.

In a particular embodiment, the plastic films obtained with the composition according to the invention also have the following properties,
1. an elastic modulus greater than 200 MPa longitudinally and greater than 150 MPa transversely, measured according to standard EN ISO 527-3 and/or
2. a maximum stress greater than 15 MPa longitudinally and greater than 13 MPa transversely, measured according to standard EN ISO 527-3.

The composition according to the invention can also be used for the production of rigid plastic products such as food packaging.

### EXAMPLES

### Example 1

A) Production of the Compositions

The compositions were produced on a Leistritz ZSE 18MAXX twin-screw co-rotating extruder. Solids such as polymers and compatibilizer were introduced using one or two gravimetric dosing devices depending on the composition. Indeed, for the compositions containing the compatibilizer Joncryl® ADR 4468 C, the PLA (4043D) and compatibilizer mixture was first introduced at the beginning of the extruder via a first dosing device, then the PBAT (Ecoflex® C1200) was introduced in a delayed manner via a second dosing device. For the compositions without compatibilizer, PLA and PBAT were mixed and introduced with a dosing device at the beginning of the extrusion. The plasticizer Glyplast® OLA8 was preheated to 70° C. and introduced with a peristaltic pump. The more-fluid plasticizer Glyplast® OLA2 was introduced with a Brabender liquid pump. The plasticizers were introduced at the beginning of extrusion. CaCO3 was introduced with a gravimetric dosing device in zone 7/10.

All compositions were prepared under the same process conditions with a screw speed of 70 rpm and at a throughput of 2 to 4 kg/hour.

The parameters used for the extrusion of the compositions are presented in Table 1.

TABLE 1

| Zone | Z1 | Z2 | Z3 | Z4 | Z5 | Z6 | Z7 | Z8 | Z9 | Nozzle |
|---|---|---|---|---|---|---|---|---|---|---|
| Temperature (° C.) | 190 | 190 | 190 | 185 | 185 | 185 | 185 | 180 | 180 | 180 |

The mixture of the components arrives in a molten state in the last zone of the twin-screw extruder which has a die with a 3.5 mm diameter hole and is immediately immersed in a 2 m water tank and fed to a granulator to obtain cylindrical granules with a diameter of less than 3 mm.

The granules obtained have the compositions described in Table 2 (% by weight in relation to the total weight of the composition)

TABLE 1

| | | | Glyplast | Glyplast | Joncryl ® | |
|---|---|---|---|---|---|---|
| | PLA | PBAT | OLA 2 | OLA 8 | ADR 4468 C | CaCO3 |
| 1 | 29 | 70 | | | 1 | |
| 2 | 29 | 68 | 3 | | | |
| 3 | 29 | 67 | 3 | | 1 | |
| 4 | 29 | 68 | | 3 | | |
| 5 | 29 | 67 | | 3 | 1 | |
| 6 | 29 | 64 | | 3 | 1 | 3 |

B) Production of Films with the Compositions Described in A)

The compositions 1 to 6 prepared in A) were used for the preparation of films. For the extrusion-blow molding, a LabTech LF-250 laboratory line, width 20 mm, 30 L/D screw type LBE20-30/C was used. Before the extrusion-blow molding the compositions were dried in a desiccator 4 h at 80° C. The screw speed was 60 rpm. The inflation rate was about 5.

The settings for the extrusion-blow molding temperatures are detailed in Table 3.

TABLE 2

| Zone | Z1 | Z2 | Z3 | Z4 | Line# 1 | Line #2 |
|---|---|---|---|---|---|---|
| T° C. | 150 | 150 | 150 | 150 | 155 | 155 |

The average thicknesses of the produced films measured with a micrometer are given in Table 4.

TABLE 3

| | | Thickness |
|---|---|---|
| Granules | Film | (μm) |
| Composition 1 | Film 1 | 16 |
| Composition 2 | Film 2 | 12 |
| Composition 3 | Film 3 | 17 |
| Composition 4 | Film 4 | 15 |
| Composition 5 | Film 5 | 15 |
| Composition 6 | Film 6 | 16 |

C) Characterization of the Mechanical Properties in Single Tension and in Tearing

The films were then mechanically characterized in single tension and in tearing using a Zwick testing machine equipped with a 50 N sensor. The experimental conditions per test type are summarized in Table 5.

A “pants” type test tube is used for the tear test.

Two important criteria in the application area of bag manufacture are elongation at break and tear resistance. Tearing is characterized only in the transverse direction of the film.

TABLE 4

| | Sample dimensions | Distance between | Crosshead |
|---|---|---|---|
| Test | (mm*mm) | jaws (mm) | speed (mm/min) |
| Single | 15*150 | 80 | 100 |
| tension | | | |
| Tearing | 50*150 | 75 | 120 |

The results obtained for Films 1 to 6 are given in Table 6 (MD=Longitudinal Direction; TD=Transverse Direction).

TABLE 5

| | Test | Elongation | Tear resistance |
|---|---|---|---|
| Film | direction | at break (%) | (N/mm) |
| Film 1 | MD | 200 | — |
| | TD | 250 | 38.9 |
| Film 2 | MD | 150 | — |
| | TD | 170 | 10.5 |
| Film 3 | MD | 170 | — |
| | TD | 260 | 47.0 |
| Film 4 | MD | 120 | — |
| | TD | 190 | 11.0 |
| Film 5 | MD | 210 | — |
| | TD | 270 | 48.7 |
| Film 6 | MD | 220 | — |
| | TD | 250 | 46.9 |

The inventors have established a set of specifications to be reached allowing the sale of the films of the invention in the bagging market, namely that it is desirable that the films of the invention reach the following values:

Elongation at break, which measures the ability of a material to elongate under load before breaking: 130% longitudinally and 240% transversely measured according to standard EN ISO 527-3.

Tear resistance: 40 N/mm transversely and measured according to the conditions of standard DIN EN ISO 6383 at 200 mm/min or under the conditions as described in this example.

By comparing the properties of Films 1, 2, 3, 4 and 5 it can be observed that the composition described in the invention (Films 3 or 5) makes it possible to achieve the properties of the set of specifications defined above. Indeed, the presence of the compatibilizer Joncryl® (Film 1) or the plasticizer Glyplast® OLA 2 or Glyplast® OLA 8 (Film 2 and 4 respectively) alone does not allow it.

It is thus possible, with the composition according to the invention, to increase the PLA content in the films while preserving the properties of the desired specifications.

By comparing Films 5 and 6, it is shown that the addition of CaCO3 has no negative effect on the elongation and tearing properties of the composition according to the invention.

The films of the invention must also meet criteria of elastic modulus and maximum stress. The elastic modulus and maximum stress characteristics of the films are given in Table 7.

TABLE 6

| | Test | Elastic | Maximum |
|---|---|---|---|
| Film | direction | modulus (MPa) | stress (MPa) |
| Film 1 | MD | 374 | 28 |
| | TD | 209 | 13 |
| Film 2 | MD | 955 | 32 |
| | TD | 218 | 13 |
| Film 3 | MD | 304 | 20 |
| | TD | 195 | 15 |
| Film 4 | MD | 827 | 21 |
| | TD | 210 | 13 |
| Film 5 | MD | 288 | 23 |
| | TD | 176 | 16 |
| Film 6 | MD | 351 | 26 |
| | TD | 211 | 15 |

The specifications established by the inventors and adapted to the bagging market require that the films reach the following values:

Elastic modulus: 200 MPa longitudinally and 150 MPa transversely

Maximum stress: 15 MPa longitudinally and 13 MPa transversely

All the films resulting from the invention have properties of elastic modulus and maximum stress not deteriorated in comparison with films of the state of the art, and corresponding to the values required by the specifications defined above.

### Example 2

A) Production of the Composition

The granules were produced on a twin-screw co-rotating Clextral Evolum 25 HT. To introduce the polymers (PLA 4043D and PBAT Ecoflex® C1200) and the compatibilizer, two gravimetric dosing devices were used. Glyplast® OLA8 was introduced using a peristaltic pump after preheating to 70° C.

The PLA and Joncryl® mixture was introduced via a dosing device at the beginning of the screw in the presence of the plasticizer Glyplast® OLA 8. The mixture is melted and fed into the PBAT introduction zone.

The granules were prepared with an auger speed of 500 rpm and a throughput of 40 kg/h.

The parameters used for the extrusion of the granules are shown in Table 8.

TABLE 7

| Zone | Z1 | Z2 | Z3 | Z4 | Z5 | Z6 | Z7 | Z8 | Z9 | Z10 | Z11 | Z12 |
|---|---|---|---|---|---|---|---|---|---|---|---|---|
| Temperature | 40 | 190 | 190 | 190 | 190 | 190 | 190 | 190 | 190 | 190 | 190 | 190 |

The mixture of the components arrives in the melted state in the screw in Z12 and is immediately immersed in a 2.5 m water tank and fed to a granulator to obtain cylindrical granules with a diameter of less than 3 mm.

Two compositions are prepared, a composition 7 corresponding to the state of the art comprising 30% PLA and 70% PBAT and a composition 8 according to the invention comprising 29% PLA, 67% PBAT, 3% Glyplast® OLA 8 and 1% Joncryl® ADR 4468 C (% by weight in relation to the total weight of the composition).

B) Production of the Film with the Compositions Described in A)

The granules prepared as described in A) were used for extrusion-blow molding with the same process and parameters described in Example 1 part B).

The film 7 of composition 7 has an average thickness of 10 μm. The film 8 of composition 8 has an average thickness of 14 μm. The thicknesses were measured with a micrometer.

C) Characterization of the Mechanical Properties in Single Tension and in Tearing

The films were then characterized mechanically in single tension and in tearing using a Lloyd LS5 testing machine equipped with a 20 N sensor and using standards EN ISO 527-3 and EN ISO 6383-1, respectively. The experimental conditions by type of test are summarized in Table 9.

A “pants” type test tube is used for the tear test.

TABLE 8

| | Sample dimensions | Distance between | Crosshead |
|---|---|---|---|
| Test | (mm*mm) | jaws (mm) | speed (mm/min) |
| Single | 15*150 | 80 | 100 |
| tension | | | |
| Tearing | 50*150 | 75 | 200 |

The elongation at break and tearing characteristics of the composition are given in Table 10.

TABLE 9

| | Test | Elongation | Tear resistance |
|---|---|---|---|
| Film | direction | at break (%) | (N/mm) |
| Film 7 | MD | 119 | — |
| | TD | 369 | 19 |
| Film 8 | MD | 260 | — |
| | TD | 389 | 65 |

The elastic modulus and maximum stress characteristics of the films are given in Table 11.

TABLE 10

| | Test | Elastic | Maximum |
|---|---|---|---|
| Film | direction | modulus (MPa) | stress (MPa) |
| Film 7 | MD | 730 | 39 |
| | TD | 180 | 35 |
| Film 8 | MD | 287 | 32 |
| | TD | 166 | 22 |

Film 8 according to the invention meets all the properties of the specifications defined by the inventors, unlike film 7.

### Example 3—Comparison Using Another Plasticizer

A composition 9 based on dibutyl sebacate (DBS) produced using the same compounding and extrusion-blow molding processes as Example 1 was produced for comparison. Composition 9 comprises 29% PLA 4043D, 67% PBAT C1200, 3% DBS and 1% Joncryl® ADR 4468C.

The film 9 corresponding to composition 9 was characterized under the same conditions as the films in Example 1 part D).

Its elongation at break and tearing characteristics are given in Table 12.

TABLE 11

| | Test | Elongation | Tear resistance |
|---|---|---|---|
| Film | direction | at break (%) | (N/mm) |
| Film 9 | MD | 160 | — |
| | TD | 190 | 37.5 |

In contrast to the plasticizer selected for the composition according to the invention, the use of a usual plasticizer such as DBS does not meet all the specifications defined by the inventors and adapted to the bagging market, the elongation at break in the transverse direction being less than the required 240% and its breaking strength being less than the required 40 N/mm.

### REFERENCES

CN 106881929
EP 2 256 149
U.S. Pat. Nos. 6,841,597, 5,436,078, 9,096,758, US 2005/0154114
WO 2007/118828, WO 2002/059202, WO 2002/059199, WO 2002/059198, WO 2004/052646, WO 2012/141660, WO 2013/093355, WO 2016/198652, WO 2016/198650, WO 2016/146540, WO 2016/062695, WO 2019/043145 and WO 2019/043134

1. A plastic composition comprising:
a. at least 20% by weight polylactic acid (PLA),
b. at least 45% by weight of a polyester selected from polybutylene adipate terephthalate (PBAT), polyhydroxyalkanoates (PHAs), polybutylene succinate (PBS), polybutylene succinate adipate (PBSA) and mixtures thereof,
c. a PLA/polyester compatibilizer, and
d. a plasticizer selected from lactic acid oligomers (OLA).

2. The composition according to claim 1, wherein the polyester b) is PBAT.

3. The composition according to claim 1, wherein the compatibilizer is selected from polyacrylates.

4. The composition according to claim 3, wherein the compatibilizer is selected from methacrylate derivatives.

5. The composition according to claim 4, wherein the compatibilizer is poly(ethylene-co-methyl acrylate-co-glycidyl methacrylate).

6. The composition according to claim 1, wherein the OLAs have a molecular weight of less than 1500 g/mol.

7. The composition according to claim 1, wherein the composition comprises at least 25% PLA.

8. The composition according to claim 1, wherein the polyester b) content is at least 50% of the total weight of the composition.

9. The composition according to claim 1, wherein the compatibilizer c) content is from 0.5 to 2% by weight in relation to the total weight of the composition.

10. The composition according to claim 1, wherein the OLA plasticizer d) content is from 1 to 5% by weight in relation to the total weight of the composition.

11. The composition according to claim 1, further comprising polyester-degrading enzymes.

12. A plastic film, wherein said plastic film comprises at least one layer of the composition according to claim 1.

13. A process for the preparation of the composition according to claim 1, wherein the process comprises the steps of
1. mixing the PLA a) and the compatibilizer c) selected from polyacrylates at a temperature where the PLA is partially or completely melted,
2. adding the polyester b) at a temperature where the previously obtained mixture is partially or completely melted, and
3. adding the plasticizer d) at any time during the process

14. The composition according to claim 11, wherein the composition further comprises from 0.0005% to 10% enzymes.

15. The plastic film according to claim 12, wherein said film is a single layer film.

16. The plastic film according to claim 12, wherein said composition further comprises polyester degrading enzymes.

17. The process according to claim 13, wherein step 1) comprises mixing at least 25% by weight PLA and between 0.5% and 1.5% by weight compatibilizer, in relation to the total weight of the composition.

18. The process according to claim 13, wherein step 2) comprises adding at least 60% by weight of the polyester in relation to the total weight of the composition.

19. The process according to claim 13, wherein the plasticizer content is between 2 to 4% by weight of the total weight of the composition.

20. The process according to claim 13, wherein the preparation of the composition is done by extrusion.
